(19) United States
(12) Patent Application Publication
(10) Pub. No.: US 2023/0061445 A1
(43) Pub. Date: Mar. 2, 2023

(54) ELECTRONIC DEVICE FOR OUTPUTTING VOICE COMMAND PROCESSING RESULT BASED ON STATE CHANGE AND OPERATING METHOD THEREOF

(71) Applicant: Samsung Electronics Co., Ltd., Gyeonggi-do (KR)

(72) Inventors: Jungkeun CHO, Gyeonggi-do (KR); Jisu SON, Gyeonggi-do (KR)

(21) Appl. No.: 17/846,631

(22) Filed: Jun. 22, 2022

Related U.S. Application Data
(63) Continuation of application No. PCT/KR2022/007541, filed on May 27, 2022.

(30) Foreign Application Priority Data
Aug. 10, 2021 (KR) 10-2021-0105110

(51) Int. Cl. G10L 15/22; G10L 15/30; G06V 10/74; G06F 21/32

(52) U.S. Cl. CPC G10L 15/22; G10L 15/30; G06V 10/74; G06F 21/32; G10L 2015/228; G10L 2015/223

(57) ABSTRACT

Methods and electronic devices are disclosed herein. A first electronic device may implement a first method, including receiving a voice command, detecting a state of the electronic device, and transmitting the voice command and state to a second electronic device, which may be an artificial intelligence (AI) server. The AI server may implement a second method, including processing the information and return a processing result set. The first electronic device may generate a target processing result, based on the processing result set and a newly detected state of the first electronic device, and output the target processing result.

### CROSS-REFERENCE TO RELATED APPLICATIONS

This application is a continuation of International Application No. PCT/KR2022/007541 designating the United States, filed on May 27, 2022, in the Korean Intellectual Property Receiving Office and claiming priority to Korean Patent Application No. 10-2021-0105110, filed on Aug. 10, 2021, in the Korean Intellectual Property Office, the disclosures of which are incorporated by reference herein in their entireties.

### BACKGROUND

### 1. Technical Field

The disclosure relates to artificial intelligence (AI) assisted operations, and more particularly, to AI-assisted operations based on voice commands contextual to a present state of an electronic device.

### 2. Description of Related Art

Electronic devices now commonly include voice assistant functions capable of retrieving and executing services and functions, by receiving a user utterance as an input. The user utterance is often parsed and analyzed via an artificial intelligence (AI) server which extracts a meaning and intent of the user utterance, via, for example, so-called natural language processing. The AI server may thus infer and/or interpret certain meanings from the utterance, and retrieve and execute a corresponding tax based on the inference and interpretation, while facilitating reception of inputs through natural conversational interactions between the user and the AI server.

### SUMMARY

In some implementations, the AI server, in discerning the intent of an utterance, may analyze various pieces of information that are associated with the utterance, as based on a state of the electronic device detected around the time of the utterance.

When state information is used to discern an intent of a user via their utterance, different states may be extant at the time the user utterance is received. As a result, a problem occurs in that an AI server may return a processed intent that is discordant with the user's actual intent.

Various example embodiments of the disclosure may thus remedy this issue, by providing an electronic device configured to receive a command processing result set from an AI server, collect state information, in response to the receiving of the command processing result set, output a processing result corresponding to the intent of a user, based on the processing result set and state information collected in response to the receiving of the processing result set.

Various example embodiments of the disclosure may provide an electronic device configured to transmit a voice command and state information to an intelligent server, receive a processing result set, including a plurality of processing results, from the intelligent server, and select a processing result, based on state information recollected in response to the receiving of the processing result set.

According to example embodiments, an operating method in an electronic device is disclosed, including: in response to receiving, via a microphone, a voice command of a user, detecting a state of the electronic device from as first context information; transmitting, via a communication circuitry, and to an intelligent server, the first context information and the voice command of the user; receiving, from the intelligent server, a processing result set including at least one processing result generated based on the first context information and the voice command of the user; in response to the receiving of the processing result set, redetecting, via at least one processor, the state of the electronic device as second context information; generating a target processing result, based on the second context information and the processing result set; and outputting, via output circuitry, the target processing result.

According to example embodiments, an electronic device is disclosed, including: a microphone; a communication module; a memory configured to store computer-executable instructions; and a processor operatively coupled to the microphone, the communication module and the memory, wherein the instructions are executable by the processor to cause the electronic device to: in response to receiving, via the microphone, a voice command of a user, detect a state of the electronic device from as first context information, transmit, via the communication module, and to an intelligent server, the first context information and the voice command of the user, receive, from the intelligent server, a processing result set including at least one processing result generated based on the first context information and the voice command of the user, in response to the receiving of the processing result set, redetect, via at least one processor, the state of the electronic device as second context information, generate a target processing result, based on the second context information and the processing result set, and outputting the target processing result.

According to example embodiments, an intelligent server is disclosed, including: a communication module; a memory configured storing computer-executable instructions; and a processor operably coupled to the memory and the communication module, wherein the instructions are executable by the processor to cause the intelligent server to: receive, via the communication module, from an external electronic device, a voice command of a user, and first context information indicating a state of the external electronic device, process the received voice command and the first context information to generate a processing result set, and transmit the processing result set to the external electronic device via the communication module.

Various example embodiments of the disclosure may provide an electronic device configured to output a voice command processing result corresponding to the intent of a user by collecting state information on the electronic device.

In addition, various effects directly or indirectly ascertained through the present disclosure may be provided.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device in a network environment, according to various example embodiments;

FIG. 2 is a block diagram illustrating an integrated intelligence system according to an example embodiment;

FIG. 3 is a diagram illustrating a user terminal displaying a screen for processing a voice input received through an intelligent app, according to an example embodiment;

FIG. 4 is a diagram illustrating a form in which relationship information between concepts and actions is stored in a database, according to an example embodiment;

FIG. 5 is a block diagram illustrating an electronic device and an intelligent server, according to various example embodiments;

FIGS. 6A and 6B are diagrams each illustrating an operation of processing a command that needs an electronic device to be unlocked, according to an example embodiment;

FIG. 7 is a diagram illustrating an operation of deleting an image from an electronic device, according to an example embodiment;

FIG. 8 is a diagram illustrating an operation when an intelligent server communicates with multiple electronic devices, according to various example embodiments;

FIG. 9 is a flowchart illustrating an operation of an electronic device, according to various example embodiments;

FIG. 10 is a flowchart illustrating an operation of an electronic device, based on whether a voice command is processible by the electronic device, according to various example embodiments;

FIG. 11 is a flowchart illustrating an operation of generating a target processing result, based on second context information and a processing result set, according to various example embodiments; and

FIG. 12 is a flowchart illustrating an operation of an intelligent server, according to various example embodiments.

### DETAILED DESCRIPTION

Hereinafter, various example embodiments will be described in greater detail with reference to the accompanying drawings. When describing the example embodiments with reference to the accompanying drawings, like reference numerals refer to like elements and a repeated description related thereto will be omitted.

<Electronic Device and Intelligent Server>

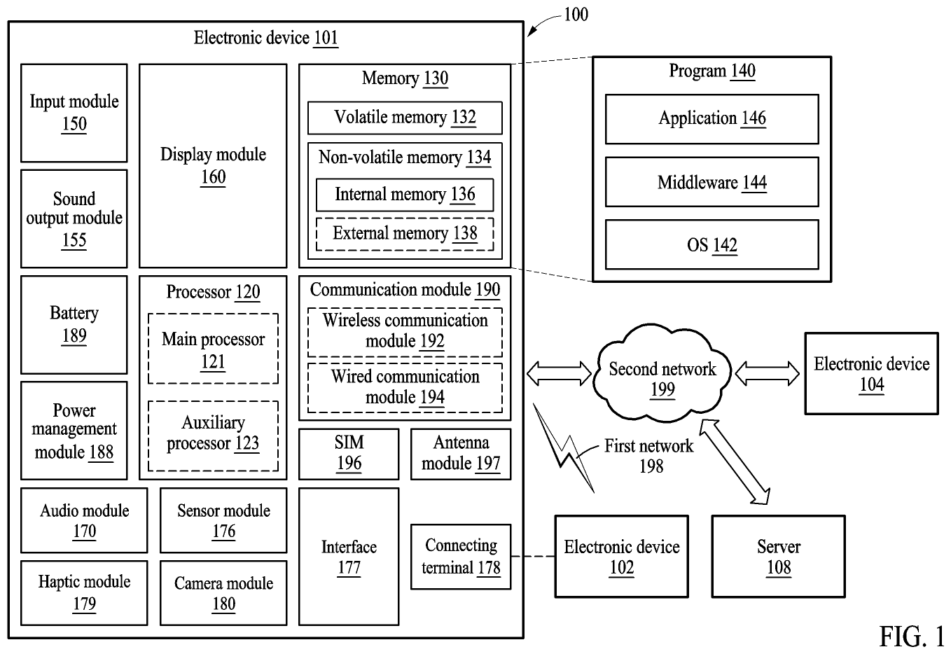

FIG. 1 is a block diagram illustrating an electronic device 101 in a network environment 100 according to various example embodiments.

FIG. 1 is a block diagram illustrating an electronic device 101 in a network environment 100 according to various example embodiments. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an example embodiment, the electronic device 101 may communicate with the electronic device 104 via the server 108. According to an example embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, and an antenna module 197. In some example embodiments, at least one of the components (e.g., the connecting terminal 178) may be omitted from the electronic device 101, or one or more other components may be added in the electronic device 101. In some example embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an example embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an example embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an example embodiment, the auxiliary processor 123 (e.g., an ISP or a CP) may be implemented as a portion of another component (e.g., the camera module 180 or the communication module 190) that is functionally related to the auxiliary processor 123. According to an example embodiment, the auxiliary processor 123 (e.g., an NPU) may include a hardware structure specified for artificial intelligence model processing. An artificial intelligence model may be generated by machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure in addition to the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an example embodiment, the receiver may be implemented separately from the speaker or as a part of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, and the projector. According to an example embodiment, the display module 160 may include a touch sensor adapted to sense a touch, or a pressure sensor adapted to measure an intensity of a force incurred by the touch.

The audio module 170 may convert a sound into an electric signal or vice versa. According to an example embodiment, the audio module 170 may obtain the sound via the input module 150 or output the sound via the sound output module 155 or an external electronic device (e.g., an electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an example embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, a Hall sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an example embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an example embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. According to an example embodiment, the haptic module 179 may include, for example, a motor, a piezoelectric element, or an electric stimulator.

The camera module 180 may capture a still image and moving images. According to an example embodiment, the camera module 180 may include one or more lenses, image sensors, ISPs, or flashes.

The power management module 188 may manage power supplied to the electronic device 101. According to an example embodiment, the power management module 188 may be implemented as, for example, at least a part of a power management integrated circuit (PMIC).

The battery 189 may supply power to at least one component of the electronic device 101. According to an example embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently of the processor 120 (e.g., an AP) and that support a direct (e.g., wired) communication or a wireless communication. According to an example embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an example embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an example embodiment, the antenna module 197 may include an antenna including a radiating element including a conductive material or a conductive pattern formed in or on a substrate (e.g., a printed circuit board (PCB)). According to an example embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an example embodiment, another component (e.g., a radio frequency integrated circuit (RFIC)) in addition to the radiating element may be additionally formed as a part of the antenna module 197.

According to various example embodiments, the antenna module 197 may form a mmWave antenna module. According to an example embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an example embodiment, all or some of operations to be executed by the electronic device 101 may be executed at one or more external electronic devices (e.g., the external devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an example embodiment, the external electronic device 104 may include an Internet-of-things (IoT) device. The server 108 may be an intelligent server using machine learning and/or a neural network. According to an example embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

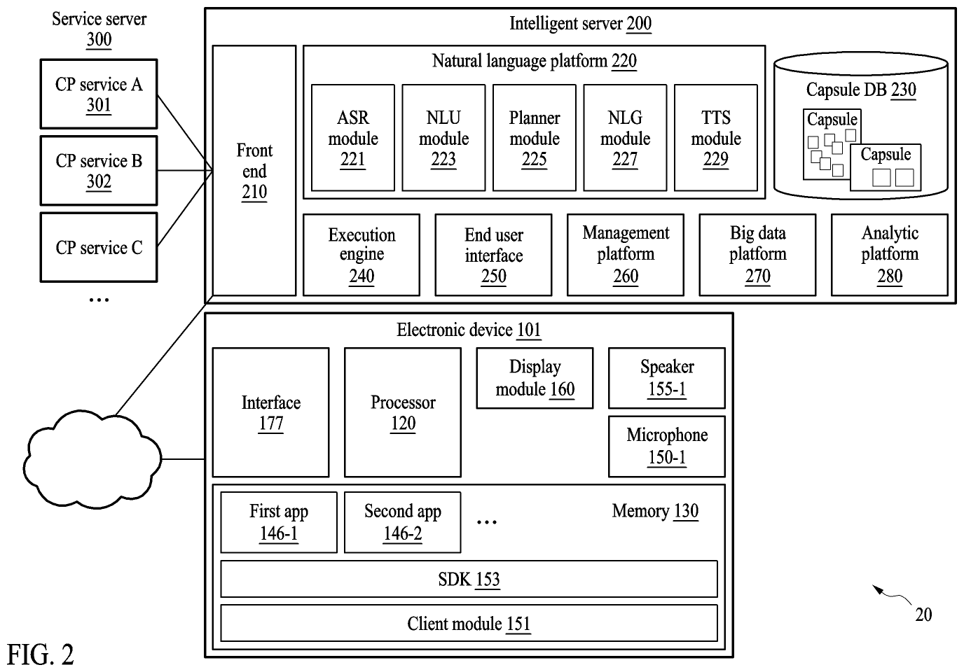

FIG. 2 is a block diagram illustrating an integrated intelligence system according to an example embodiment.

Referring to FIG. 2, an integrated intelligence system 20 may include an electronic device 101, an intelligent server 200, and a service server 300.

The electronic device 101 may be a terminal device (or an electronic device) connectable to the Internet and may be, for example, a mobile phone, a smartphone, a personal digital assistant (PDA), a notebook computer, a television (TV), a white home appliance, a wearable device, a head-mounted display (HMD), or a smart speaker.

According to an illustrated example embodiment, the electronic device 101 may include an interface 177, a microphone 150-1, a speaker 155-1, a display module 160, a memory 130, and a processor 120. The components listed above may be operationally or electrically connected to each other. The microphone 150-1 may be included in an input module (e.g., the input module 150 of FIG. 1). The speaker 155-1 may be included in a sound output module (e.g., the sound output module 155 of FIG. 1).

The interface 177 may be connected to an external device and configured to transmit and receive data to and from the external device. The microphone 150-1 may receive sound (e.g., a user utterance) and convert the sound into an electrical signal. The speaker 155-1 may output the electrical signal as sound (e.g., speech). The display module 160 may be configured to display an image or a video. The display module 160 may also display a graphical user interface (GUI) of an executed app (or an application program).

The memory 130 may store a client module 151, a software development kit (SDK) 153, and a plurality of apps 146-1 and 146-2. The client module 151 and the SDK 153 may configure a framework (or a solution program) for performing a general-purpose function. In addition, the client module 151 or the SDK 153 may configure a framework for processing a voice input.

The plurality of apps 146-1 and 146-2 may be programs for performing a designated function. The plurality of apps 146-1 and 146-2 may include a first app 146-1 and a second app 146-2. Each of the plurality of apps 146-1 and 146-2 may include a plurality of actions for performing a designated function. For example, the apps may each include an alarm app, a messaging app, and/or a scheduling app. The plurality of apps 146-1 and 146-2 may be executed by the processor 120 and sequentially execute at least some of the plurality of actions.

The processor 120 may control the overall operation of the electronic device 101. For example, the processor 120 may be electrically connected to the interface 177, the microphone 150-1, the speaker 155-1, and the display module 160 and perform a designated operation.

The processor 120 may also perform the designated function by executing a program stored in the memory 130. For example, the processor 120 may execute at least one of the client module 151 and the SDK 153 and perform the following operation for processing a voice input. The processor 120 may control the operation of the plurality of apps 146-1 and 146-2 through, for example, the SDK 153. The following operation described as an operation of the client module 151 or the SDK 153 may be an operation executed by the processor 120.

The client module 151 may receive a voice input. For example, the client module 151 may receive a voice signal corresponding to a user utterance sensed through the microphone 150-1. The client module 151 may transmit the received voice input to the intelligent server 200. The client module 151 may transmit, to the intelligent server 200, state information on the electronic device 101 together with the received voice input. The state information may be, for example, execution state information on an app.

The client module 151 may receive a result corresponding to the received voice input. For example, when the intelligent server 200 calculates a result corresponding to the received voice input, the client module 151 may receive the result corresponding to the received voice input. The client module 151 may display the received result on the display module 160.

The client module 151 may receive a plan corresponding to the received voice input. The client module 151 may display, on the display module 160, results of executing a plurality of actions of an app, according to the plan. The client module 151 may, for example, sequentially display the results of executing the plurality of actions on a display. As another example, the electronic device 101 may display, on the display, a partial result of executing the plurality of actions (e.g., a result of the last action).

According to an example embodiment, the client module 151 may receive, from the intelligent server 200, a request for obtaining information utilized for calculating a result corresponding to the voice input. In response to the request, the client module 151 may transmit the utilized information to the intelligent server 200.

The client module 151 may transmit, to the intelligent server 200, information on the results of executing the plurality of actions according to the plan. The intelligent server 200 may confirm that the received voice input has been correctly processed by using the information on the results.

The client module 151 may include a speech recognition module. According to an example embodiment, the client module 151 may recognize, through the speech recognition module, a voice input performing a limited function. For example, the client module 151 may execute an intelligent app for processing a voice input to perform an organic operation through a designated input (e.g., Wake up!).

The intelligent server 200 may receive information related to a user voice input from the electronic device 101 through a communication network. According to an example embodiment, the intelligent server 200 may change data related to the received voice input into text data. According to an example embodiment, the intelligent server 200 may generate a plan for performing a task corresponding to the user voice input, based on the text data.

According to an example embodiment, the plan may be generated by an artificial intelligence (AI) system. The AI system may be a rule-based system or a neural network-based system (e.g., a feedforward neural network (FNN) or an RNN). Alternatively, the AI system may be a combination thereof or other AI systems. According to an example embodiment, the plan may be selected from a set of predefined plans or may be generated in real time in response to a user request. For example, the AI system may select at least one plan from among the predefined plans.

The intelligent server 200 may transmit a result according to the generated plan to the electronic device 101 or transmit the generated plan to the electronic device 101. According to an example embodiment, the electronic device 101 may display, on the display module 160, the result according to the generated plan. According to an example embodiment, the electronic device 101 may display, on the display module 160, a result of executing an action according to the plan.

The intelligent server 200 may include a front end 210, a natural language platform 220, a capsule database (DB) 230, an execution engine 240, an end user interface 250, a management platform 260, a big data platform 270, and an analytic platform 280.

The front end 210 may receive, from the electronic device 101, the received voice input. The front end 210 may transmit a response corresponding to the voice input.

According to an example embodiment, the natural language platform 220 may include an automatic speech recognition (ASR) module 221, a natural language understanding (NLU) module 223, a planner module 225, a natural language generator (NLG) module 227, and a text-to-speech (TTS) module 229.

The ASR module 221 may convert the voice input received from the electronic device 101 into text data. The NLU module 223 may discern the intent of a user by using the text data of the voice input. For example, the NLU module 223 may discern the intent of the user by performing syntactic analysis or semantic analysis. The NLU module 223 may discern the meaning of a word extracted from the voice input by using a linguistic feature (e.g., a grammatical element) of a morpheme or phrase and determine the intent of the user by matching the discerned meaning of the word to intent.

The planner module 225 may generate a plan by using a parameter and the intent determined by the NLU module 223. According to an example embodiment, the planner module 225 may determine a plurality of domains utilized to perform a task, based on the determined intent. The planner module 225 may determine a plurality of actions included in each of the plurality of domains determined based on the intent. According to an example embodiment, the planner module 225 may determine a parameter utilized to execute the determined plurality of actions or a result value output by the execution of the plurality of actions. The parameter and the result value may be defined as a concept of a designated form (or class). Accordingly, the plan may include a plurality of actions and a plurality of concepts determined by the intent of the user. The planner module 225 may determine a relationship between the plurality of actions and the plurality of concepts stepwise (or hierarchically). For example, the planner module 225 may determine an execution order of the plurality of actions determined based on the intent of the user, based on the plurality of concepts. In other words, the planner module 225 may determine the execution order of the plurality of actions, based on the parameter utilized for the execution of the plurality of actions and results output by the execution of the plurality of actions. Accordingly, the planner module 225 may generate a plan including connection information (e.g., ontology) between the plurality of actions and the plurality of concepts. The planner module 225 may generate the plan by using information stored in the capsule DB 230 that stores a set of relationships between concepts and actions.

The NLG module 227 may change designated information into a text form. The information changed to a text form may be in the form of a natural language utterance. The TTS module 229 may change information in a text form into information in a speech form.

According to an example embodiment, some or all of the functions of the natural language platform 220 may be implemented in the electronic device 101 as well.

The capsule DB 230 may store information on the relationship between the plurality of concepts and actions corresponding to the plurality of domains. A capsule according to an example embodiment may include a plurality of action objects (or action information) and concept objects (or concept information) included in the plan. According to an example embodiment, the capsule DB 230 may store a plurality of capsules in the form of a concept action network (CAN). According to an example embodiment, the plurality of capsules may be stored in a function registry included in the capsule DB 230.

The capsule DB 230 may include a strategy registry that stores strategy information utilized for determining a plan corresponding to a voice input. The strategy information may include reference information for determining one plan when there is a plurality of plans corresponding to the voice input. According to an example embodiment, the capsule DB 230 may include a follow-up registry that stores information on follow-up actions for suggesting a follow-up action to the user in a designated situation. The follow-up action may include, for example, a follow-up utterance. According to an example embodiment, the capsule DB 230 may include a layout registry that stores layout information that is information output by the electronic device 101. According to an example embodiment, the capsule DB 230 may include a vocabulary registry that stores vocabulary information included in capsule information. According to an example embodiment, the capsule DB 230 may include a dialog registry that stores information on a dialog (or an interaction) with the user. The capsule DB 230 may update the stored objects through a developer tool. The developer tool may include, for example, a function editor for updating an action object or a concept object. The developer tool may include a vocabulary editor for updating the vocabulary. The developer tool may include a strategy editor for generating and registering a strategy for determining a plan. The developer tool may include a dialog editor for generating a dialog with the user. The developer tool may include a follow-up editor for activating a follow-up objective and editing a follow-up utterance that provides a hint. The follow-up objective may be determined based on a current set objective, a preference of the user, or an environmental condition. In an example embodiment, the capsule DB 230 may be implemented in the electronic device 101 as well.

The execution engine 240 may calculate a result by using the generated plan. The end user interface 250 may transmit the calculated result to the electronic device 101. Accordingly, the electronic device 101 may receive the result and provide the received result to the user. The management platform 260 may manage information used by the intelligent server 200. The big data platform 270 may collect data of the user. The analytic platform 280 may manage a quality of service (QoS) of the intelligent server 200. For example, the analytic platform 280 may manage the components and processing rate (or efficiency) of the intelligent server 200.

The service server 300 may provide a designated service (e.g., a food order or a hotel reservation) to the electronic device 101. According to an example embodiment, the service server 300 may be a server operated by a third party. The service server 300 may provide information to be used for generating a plan corresponding to the received voice input to the intelligent server 200. The provided information may be stored in the capsule DB 230. In addition, the service server 300 may provide result information according to the plan to the intelligent server 200.

In the integrated intelligence system 20 described above, the electronic device 101 may provide various intelligent services to the user, in response to a user input. The user input may include, for example, an input through a physical button, a touch input, or a voice input.

In an example embodiment, the electronic device 101 may provide a speech recognition service through an intelligent app (or a speech recognition app) stored therein. In this case, for example, the electronic device 101 may recognize a user utterance or a voice input received through the microphone 150-1 and provide a service corresponding to the recognized voice input to the user.

In an example embodiment, the electronic device 101 may perform a designated action alone or together with an intelligent server and/or a service server, based on the received voice input. For example, the electronic device 101 may execute an app corresponding to the received voice input and perform a designated action through the executed app.

In an example embodiment, when the electronic device 101 provides a service together with the intelligent server 200 and/or the service server, the electronic device 101 may detect a user utterance by using the microphone 150-1 and generate a signal (or voice data) corresponding to the detected user utterance. The electronic device 101 may transmit the voice data to the intelligent server 200 by using the interface 177.

The intelligent server 200 may generate, in response to the voice input received from the electronic device 101, a plan for performing a task corresponding to the voice input or a result of performing an action according to the plan. The plan may include, for example, a plurality of actions for performing a task corresponding to a voice input of a user and a plurality of concepts related to the plurality of actions. The concepts may define parameters input to the execution of the plurality of actions or result values output by the execution of the plurality of actions. The plan may include connection information between the plurality of actions and the plurality of concepts.

The electronic device 101 may receive the response by using the interface 177. The electronic device 101 may externally output a speech signal generated by the electronic device 101 by using the speaker 155-1 or externally output an image generated by the electronic device 101 by using the display module 160.

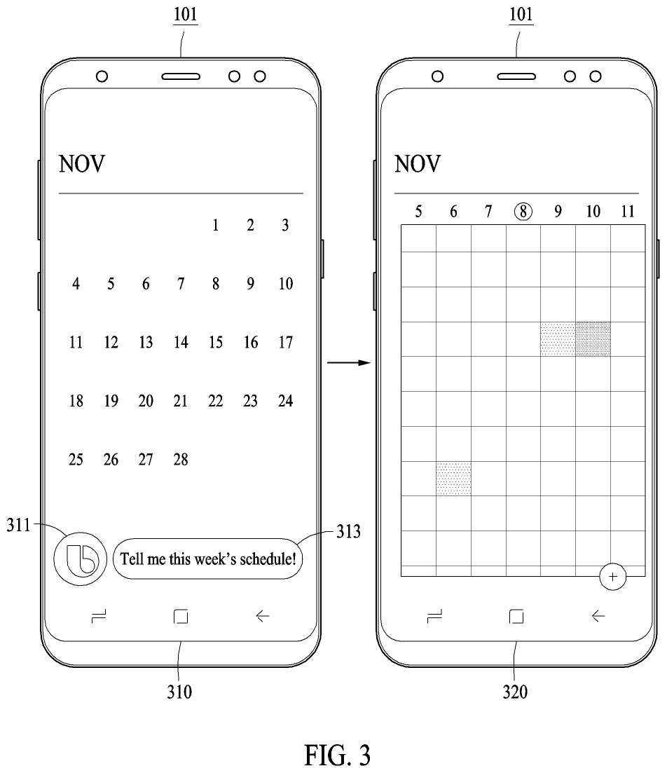

FIG. 3 is a diagram illustrating a screen for processing a voice input received through an intelligent app by an electronic device, according to an example embodiment.

An electronic device 101 may execute an intelligent app to process a user input through an intelligent server (e.g., the intelligent server 200 of FIG. 2).

According to an example embodiment, on a screen 310, when recognizing a designated voice input (e.g., Wake up!), or receiving an input through a hardware key (e.g., a dedicated hardware key), the electronic device 101 may execute an intelligent app for processing the voice input. The electronic device 101 may execute the intelligent app, for example, in a state in which a scheduling app is executed and displayed. According to an example embodiment, the electronic device 101 may display, on a display (e.g., the display module 160 of FIG. 1), an object 311 (e.g., an icon) corresponding to the intelligent app. According to an example embodiment, the electronic device 101 may receive a voice input by a user utterance. For example, the electronic device 101 may receive a voice input including, “Tell me this week's schedule!” According to an example embodiment, the electronic device 101 may display, on the display, a user interface (UI) 313 (e.g., an input window) of the intelligent app in which text data included in the received voice input is entered.

According to an example embodiment, on a screen 320, the electronic device 101 may display, on the display, a result corresponding to the received voice input. For example, the electronic device 101 may retrieve a scheduling plan corresponding to the received user input (e.g., a schedule for a present week corresponding to a present time), and display, on the display, the retrieved schedule plan.

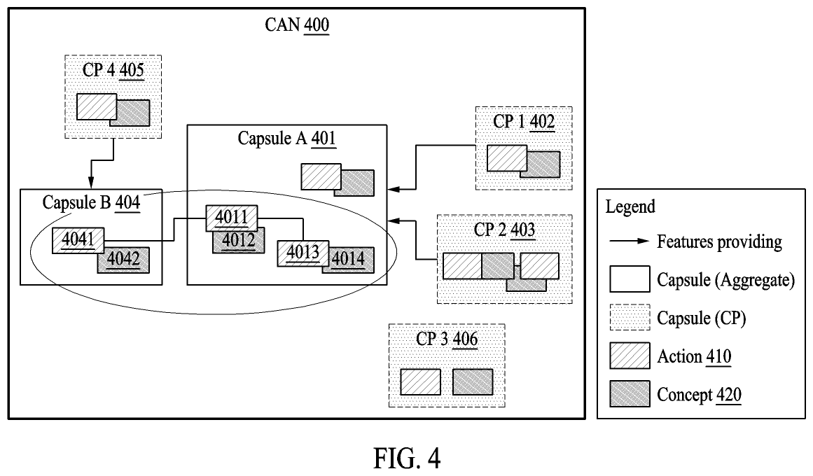

FIG. 4 is a diagram illustrating a form in which relationship information between concepts and actions is stored in a database, according to an example embodiment.

A capsule DB (e.g., the capsule DB 230 of FIG. 2) of an intelligent server (e.g., the intelligent server 200 of FIG. 2) may store capsules in the form of a CAN. The capsule DB may store an action for processing a task corresponding to a voice input of a user and a parameter utilized for the action in the form of a CAN.

The capsule DB may store a plurality of capsules (e.g., a capsule A 401 and a capsule B 404) respectively corresponding to a plurality of domains (e.g., applications). According to an example embodiment, one capsule (e.g., the capsule A 401) may correspond to one domain (e.g., a location or “geo” or an application). Further, the one capsule may correspond to at least one service provider (e.g., a CP 1 402 or a CP 2 403) for performing a function for a domain related to the capsule. According to an example embodiment, one capsule may include at least one action 410 for performing a designated function and at least one concept 420.

A natural language platform (e.g., the natural language platform 220 of FIG. 2) may generate a plan for performing a task corresponding to the received voice input by using the capsules stored in the capsule DB. For example, a planner module (e.g., the planner module 225 of FIG. 2) of the natural language platform may generate the plan by using the capsules stored in the capsule DB. For example, a plan may be generated by using actions 4011 and 4013 and concepts 4012 and 4014 of the capsule A 401 and an action 4041 and a concept 4042 of the capsule B 404.

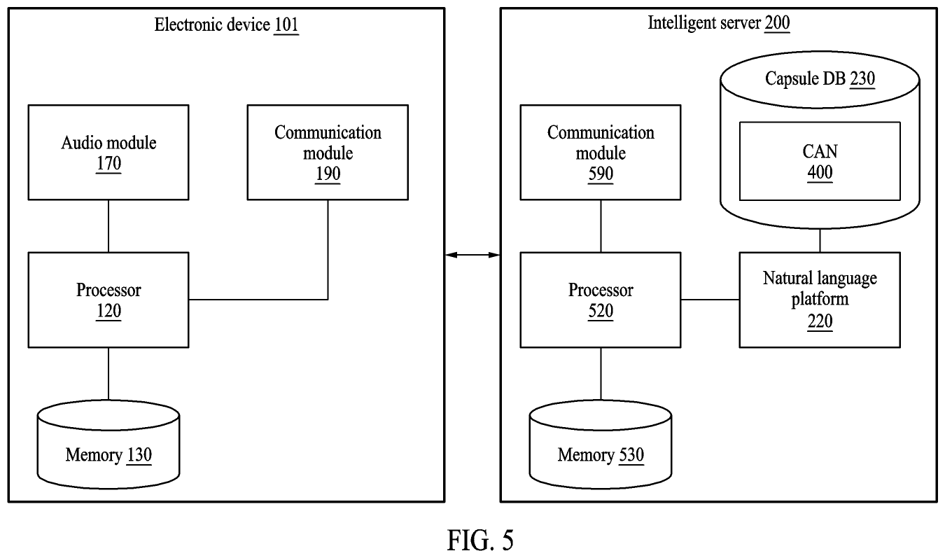

FIG. 5 is a block diagram illustrating an electronic device 101 and an intelligent server 200, according to various example embodiments.

Referring to FIG. 5, the electronic device 101 may include an audio module 170 for receiving a voice command of a user, a communication module 190 for communicating with the intelligent server 200 for processing the voice command of the user, a memory 130 for storing computer-executable instructions, and a processor 120 for executing the instructions by accessing the memory 130. According to an example embodiment, the electronic device 101, the audio module 170, the communication module 190, the memory 130, and the processor 120 may respectively correspond to the electronic device 101, the audio module 170, the communication module 190, the memory 130, and the processor 120 described with reference to FIG. 1.

According to an example embodiment, the memory 130 of the electronic device 101 may store, as software, a program (e.g., the program 140 of FIG. 1) for collecting context information on a state of the electronic device 101, and outputting a processing result corresponding to the intent of the user, based on the context information and a processing result set received from the intelligent server 200. The memory 130 may include, for example, an OS (e.g., the OS 142 of FIG. 1), middleware (e.g., the middleware 144 of FIG. 1), or an application (e.g., the application 146 of FIG. 1). The instructions stored in the memory 130 may be implemented as a function module in the OS (e.g., the OS 142 of FIG. 1), implemented in the form of middleware (e.g., the middleware 144 of FIG. 1), or implemented in the form of a separate application (e.g., the application 146 of FIG. 1).

According to an example embodiment, the electronic device 101 may be the electronic device 101 for communicating with the intelligent server 200 described with reference to FIG. 2, and a client module (e.g., the client module 151 of FIG. 2) may be included in the memory 130.

According to an example embodiment, the processor 120 may receive a voice command of a user through the audio module 170, and in response to the receiving of the voice command of the user, collect first context information on a state of the electronic device 101. According to various example embodiments, context information on a state of the electronic device 101 may include at least one of information on whether the electronic device 101 is locked or unlocked, information on a current location of the electronic device 101, information on a ringtone set value, information on an operating system or application, information on a folding state, and information on whether location information is currently in-use by the user or idle. For example, context information may be represented in Table 1. However, information, collected by the processor 120 of the electronic device 101, on a state of the electronic device 101 may not be limited to the context information in Table 1, and other pieces of information on the electronic device 101 may be collected.

TABLE 1

| Context | Description | Value |
|---|---|---|
| device locked | whether a device | true/false |
| | is locked | |
| latitude, longitude | current location | double |
| location disabled | whether location | true/false |
| | information is used | |
| ringer state | current ringtone | alarm/phone/ |
| | set value | timer/other |
| driving mode | whether a user is | true/false |
| | driving (whether a | |
| | navigation app is used) | |
| fold state | current state of a | true/false |
| | foldable device | |
| focused app | package information | |
| | on a currently | |
| | operating application | |

According to an example embodiment, the processor 120, may transmit, to the intelligent server 200 via the communication module 190, the voice command of the user and the first context information collected in response to the receiving of the voice command of the user.

According to an example embodiment, the intelligent server 200 may include a natural language platform 220, a capsule DB 230, a communication module 590, a processor 520, and a memory 530.

According to an example embodiment, the intelligent server 200 may be the intelligent server 200 described with reference to FIG. 2, the communication module 590, the processor 520, the memory 530, the natural language platform 220, and the capsule DB 230 may correspond to the configuration of the intelligent server 200 of FIG. 2.

According to an example embodiment, the communication module 590 may correspond to the front end 210 of FIG. 2. The processor 520 may receive, from the electronic device 101 via the communication module 590, the voice command and the first context information, collected in the electronic device 101 in response to the receiving of the voice command, on a state of the electronic device 101. The processor 520 may transmit a processing result set, including a processing result generated by the processor 520, via the communication module 590 to the electronic device 101.

According to an example embodiment, the natural language platform 220 may include the ASR module 221, the NLU module 223, the planner module 225, the NLG module 227, and the TTS module 229 described with reference to FIG. 2. According to an example embodiment, the capsule DB 230 may store an action for processing a task corresponding to the voice command of the user and a parameter utilized for the action in the form of a CAN 400. The CAN 400 may be configured as described with reference to FIG. 4.

According to an example embodiment, the memory 530 for storing computer-executable instructions and the processor 520 for executing the instructions by accessing the memory 530 may correspond to the execution engine 240 of the intelligent server 200 described with reference to FIG. 2. For example, the natural language platform 220 may generate a plan based on the voice command of the user, and the context information, based on the capsule DB 230, and the processor 520 may generate a processing result set according to the plan.

According to an example embodiment, the processor 520 may receive, from the electronic device 101 via the communication module 590, the voice command and the first context information, generate a processing result set including at least one processing result, by using the voice command and the first context information, based on the natural language platform 220 and the capsule DB 230, and transmit the generated processing result set to the electronic device 101.

According to an example embodiment, the processor 120 of the electronic device 101, in response to the receiving of the processing result set from the intelligent server 200, may collect second context information on a state of the electronic device 101, and based on the second context information and the processing result set, may generate a target processing result corresponding to the intent of the user.

According to an example embodiment, the processor 120 of the electronic device 101 may output the target processing result to the user. The processor 120 may output the target processing result, for example, as a text through a display module (e.g., the display module 160 of FIG. 1) or as speech through the audio module 170.

According to various example embodiments, the first context information collected in response to the receiving of the voice command of the user may be different than the second context information collected in response to the receiving of a processing result from the intelligent server 200. For example, when a network environment is not desirable, the processing of the voice command in the intelligent server 200 or the communication between the electronic device 101 and the intelligent server 200 may need a considerable amount of time. Accordingly, a state of the electronic device 101 when the processor 120 receives the voice command from the user may be different than a state of the electronic device 101 when the processor 120 receives a processing result of the voice command from the intelligent server 200. Therefore, when collecting state information on the electronic device 101 in response to the receiving of the voice command, the electronic device 101, despite a state change, may output a result not corresponding to the intent of the user.

For example, the electronic device 101 may be in a locked state when the processor 120 receives, from the user, a voice command (e.g., “Show me the call log.”) for which unlocking is needed, but the electronic device 101 may be unlocked when the intelligent server 200 receives a processing result. Although the electronic device 101 has been unlocked, a result of, “Please unlock the device first” may be output by the electronic device 101. In addition, there may be unnecessary calls between the electronic device 101 and the intelligent server 200 when transmitting an unlocked state again from the electronic device 101 to the intelligent server 200 and receiving a processing result again from the intelligent server 200.

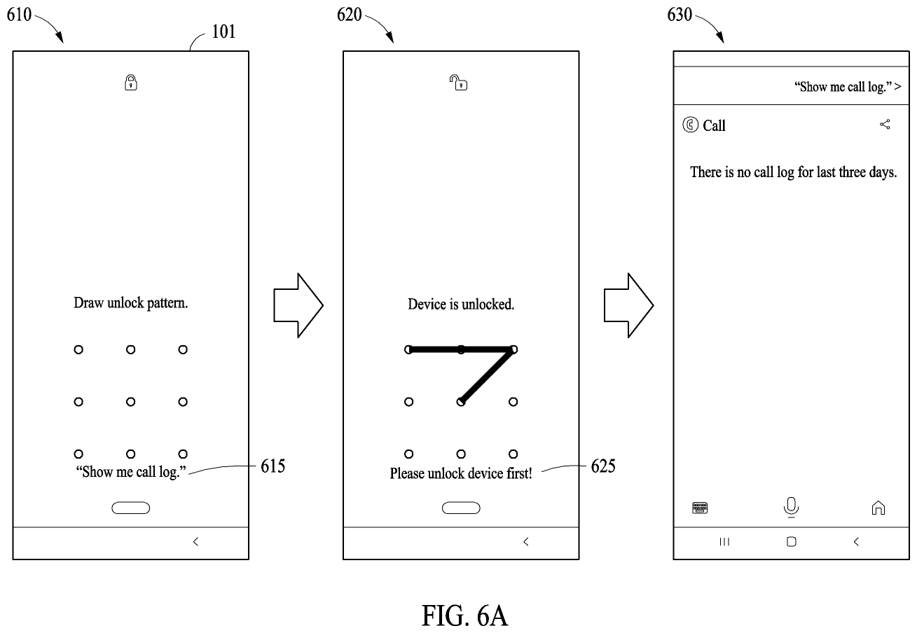

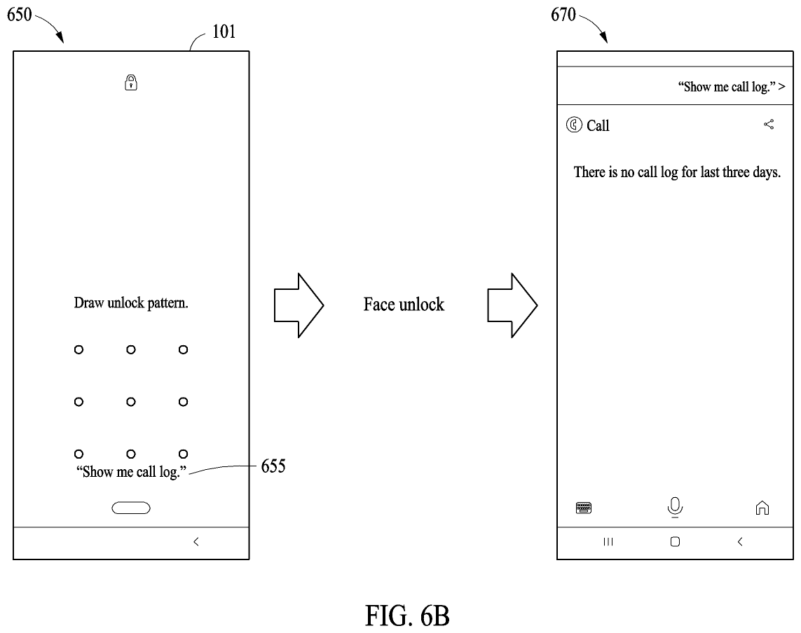

According to various example embodiments, the processor 120 of the electronic device 101 may compare the first context information collected in response to the receiving of the voice command of the user with the second context information collected in response to the receiving of a processing result set from the intelligent server 200. When the second context information is different from the first context information, the processor 120 may output, to the user, a target processing result that corresponds more to the intent of the user, based on the processing result set received from the intelligent server 200 and the second context information. An operation of outputting a target processing result corresponding to the intent of a user will be described in detail with reference to FIGS. 6A through 8.

According to an example embodiment, on-device AI for processing a voice command without communicating with the intelligent server 200 may be included in the electronic device 101. According to an example embodiment, based on the on-device AI, the processor 120 of the electronic device 101 may determine whether a voice command of a user is processible by the electronic device 101. The processor 120, when determining that the voice command of the user is not processible by the electronic device 101, may newly collect context information on a state of the electronic device 101 and further transmit the newly collected context information to the intelligent server 200. According to an example embodiment, the processor 120 may receive an improved processing result set from the intelligent server 200 by further transmitting, to the intelligent server 200, context information on a state at the time of determining that the voice command of the user is not processible by the electronic device 101 in addition to the first context information collected in response to the receiving of the voice command of the user. A specific example related to the on-device AI will be described in detail with reference to FIGS. 6A through 8 and 10.

FIGS. 6A and 6B are diagrams each illustrating an operation of processing a command that needs an electronic device to be unlocked, according to an example embodiment.

Referring to FIG. 6A, an example embodiment is described where the electronic device may process a command operable in an unlocked state of the electronic device, in which the actions of the electronic device 101 and the intelligent server 200 described with reference to FIG. 5 are not applied.

According to an example embodiment, when the electronic device 101 is disposed in a locked state as on a screen 610, a user may utter, for example, a voice command 615 of “Show me the call log,” for which the electronic device 101 must be unlocked to display.

According to an example embodiment, the processor 120 of the electronic device 101 may collect first context information on a state of the electronic device 101, and the first context information may include information that the electronic device 101 is disposed in a “locked state.” According to an example embodiment, the processor 120 may transmit the voice command 615 and the information on the “locked state” to an intelligent server (e.g., the artificial-intelligence-enabled intelligent server 200 of FIG. 5), the intelligent server 200 may transmit a processing result 625 including the output message, “Please unlock the device first!” to the electronic device 101, and the electronic device 101 may display the output message on a screen 620. The processing result 625 of the intelligent server 200 may be displayed as a text on a display screen, as in this example, or output as speech through a speaker (not shown).

According to an example embodiment, even though the electronic device 101 is disposed in a locked state as on the screen 610 when receiving a user command, the electronic device 101 may be switched to an unlocked state, as seen in the screen 620 when receiving a processing result from the intelligent server 200. Referring to the screen 620, although the electronic device 101 is unlocked when receiving the processing result, the processing result 625 corresponding to the “locked state” (i.e., the output message requesting unlock of the device) may be output by the electronic device 101. That is, the output message requesting unlock 625 may remain on the display after a user has input the unlock pattern, as seen in FIG. 6A.

The user may unlock the electronic device 101, and the electronic device 101 may display a processing result as seen in screen 630, which may include the requested call log (which in this example is empty). In some examples, the electronic device 101 in screen 630 may retransmit information on the unlocking to the intelligent server 200, and re-receive the processing result from the intelligent server 200 again.

Referring to FIG. 6B, an example is illustrated of processing a command for which unlocking is needed, when the actions of the electronic device 101 and the intelligent server 200 described with reference to FIG. 5 are performed.

According to an example embodiment, when the electronic device 101 is disposed in a locked state as on a screen 650, a user may utter, for example, a voice command 655 of “Show me the call log” for which the electronic device 101 must be unlocked in order to display.

According to an example embodiment, the processor 120 of the electronic device 101 may collect first context information on a state of the electronic device 101, in response to reception of the voice command 655. According to an example embodiment, the first context information may include information that the electronic device 101 is disposed in a “locked state.” The processor 120 may transmit the first context information including the voice command and the information on the “locked state” to an intelligent server (e.g., the intelligent server 200 of FIG. 5).

According to an example embodiment, the processor 520 of the intelligent server 200 may generate a processing result set including a resultant message, such as, “Please unlock the device first!” based on the “locked state” indicated in the first context information.

For example, the processor 520 of the intelligent server 200 may analyze the voice command 655 of “Show me the call log” via the natural language platform 220 and the capsule DB 230, and determine that an unlocking operation is to be executed, for voice command processing. According to an example embodiment, the first context information received from the electronic device 101 may include indications of a locked state, an indication that a navigational app is executing, and a current location, and the processor 520 may determine that the “locked state” as indicated by the first context information should be changed in order to successfully perform the function requested via the voice command. When the locked state is changed to an unlocked state, the processor 520 may generate, based on the natural language platform 220 and the capsule DB 230, for example, a call log for the past three days, and a processing result set including a first processing result (e.g., a message state, “Please unlock the device first!”), as based on the first context information in the locked state, and a second processing result (e.g., a message stating, “There is no call log for the last three days”) in the unlocked state. The processing result set may be represented in Table 2.

TABLE 2

| Result | | | |
|---|---|---|---|
| No. | Result | Context | Value |
| 1 | Message: “Unlock the device first” | Device | True |
| | DeepLink: “BixbyVoice://ReleaseLock; | Locked | |
| 2 | Message: “There is no call log | Device | False |
| | for the last three days.” | Locked | |
| | DeepLink: “phone://launchResult; | | |

According to an example embodiment, the intelligent server 200 may transmit the processing result set to the electronic device 101, and in response to receiving of the processing result set, the processor 120 of the electronic device 101 may redetect a state of the electronic device 101 and therefore receive second context information. When the second context information indicates that the electronic device 101 is disposed in an “unlocked state,” the processor 120 may retrieve (e.g., or generate), from the processing result set, a message stating, “There is no call log for the last three days” as a target processing result. The target processing result may be displayed as a text on a screen 670, or be output as speech via a speaker (not shown).

According to an example embodiment, as described with reference to FIG. 5, the processor 120 of the electronic device 101 may confirm whether a command is processible by the electronic device 101 before transmitting first context information and a voice command to the intelligent server 200, and when determining that the command is not processible by the electronic device 101, further collect context information and further transmit the further collected context information to the intelligent server 200. As described with reference to FIG. 5, the processor 120 may determine whether an on-device AI is included in the electronic device 101 and whether a voice command is processible by the on-device AI.

According to an example embodiment, when determining that the first context information is not processible by the electronic device 101, the processor 120 may compare the first context information with the second context information. The processor 120 may transmit both the first and second context information to the intelligent server 200, when both are the same. When both are different, the processor 120 may transmit the second collected context information to the intelligent server 200.

For example, although the processor 120 has transmitted the first context information to the intelligent server 200, indicating that the electronic device 101 is disposed in the locked state in the example embodiment described with reference to FIG. 6B, the processor 120 may transmit additional context information. The processor 120 of the electronic device 101 may determine whether the received voice command including, “Show me the call log” is processible by the electronic device 101. In some embodiments, this may result in a determination that the voice command is not processible by the electronic device 101. When the electronic device 101 is unlocked at the time the processor 120 determines that the voice command of “Show me the call log” is not processible by the electronic device 101, information related to unlocking may also be transmitted to the intelligent server 200.

According to an example embodiment, the processor 520 of the intelligent server 200 may generate a processing result set including a processing result, based on the first context information indicating that the electronic device 101 is in the locked state, and a processing result based on the context information that the electronic device 101 is disposed in the unlocked state. As described above, the processor 120 of the electronic device 101 may receive the processing result set, collect second context information in response to the receiving of the processing result set, and based on the second context information and the processing result set, generate and output a target processing result.

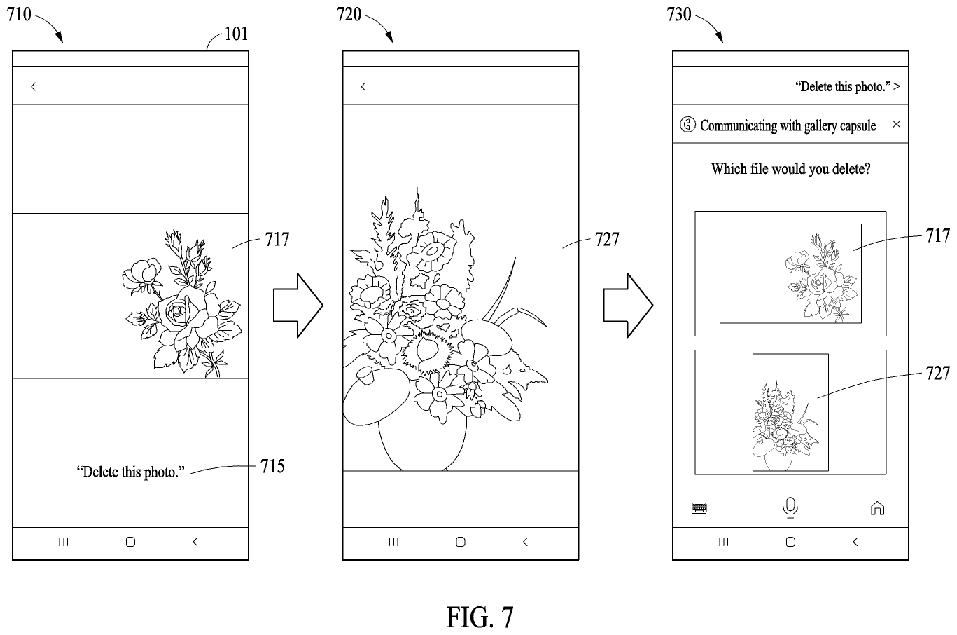

FIG. 7 is a diagram illustrating an operation of deleting an image from an electronic device, according to an example embodiment.

Referring to FIG. 7, an example embodiment is depicted, of processing an image deletion command, with reference to the operations and components of FIG. 5 for the electronic device 101 and the intelligent server 200.

According to an example embodiment, a user may utter a voice command 715 including the phrase, “Delete this photo,” when the electronic device 101 displays a first image 717 as on a screen 710. The processor 120 of the electronic device 101 may collect first context information in response to the receiving of the voice command 715. The first context information may include information on the first image 717 that is currently displayed on the screen 710, including, for example, a location where the first image 717 is stored. The processor 120 may transmit the first context information and the voice command 715 to the intelligent server 200, and the processor 520 of the intelligent server 200 may process the voice command 715, based on the natural language platform 220 and the capsule DB 230, so as to generate a processing result set.

According to an example embodiment, the processor 520 of the intelligent server 200 may generate a processing result including deletion of a second image 727, based on the location where the first image 717 is stored. For example, the processor 520 may confirm that the second image 727 stored in the same album matches with the first image 717, based on the location where the first image 717 is stored, and generate a processing result set including executing deletion of the second image 727, in addition to executing deletion of the first image 717.

According to an example embodiment, in response to receiving the processing result set from the intelligent server 200, the processor 120 of the electronic device 101 may collect second context information of the electronic device 101, including an image currently displayed by the electronic device 101. According to an example embodiment, the second context information may include information that the currently displayed image is the second image 727. For example, as seen on the screen 720, the electronic device 101, when receiving a command to delete a photo, and receiving the processing result set from the intelligent server 200, may, based on the location where the first image 717 is stored, display another image, such as, for example, the second image 727 that is included in the same album as the first image 717.

According to an example embodiment, the processor 120 may generate a target processing result, based on information that the displayed image included in the processing result set and the second context information matches with the second image 727. For example, as on a screen 730, the processor 120 may generate, as a target processing result, a message requesting the user to select between deletion of the first image 717 and deletion of the second image 727 and output the target processing result. However, the generating of a target processing result may not be limited to the foregoing example. The processor 120 may generate, as a target processing result, deletion of the first image 717 or deletion of the second image 727. According to an example embodiment, when the first image 717 matches the second image 727, the processor 120 may generate the action of deleting the first image 717 as a target processing result. According to an example embodiment, when the first image 717 is different than the second image 727, the processor 120 may generate, as a target processing result, a message that requests the user to select an image for deletion, from the processing result set.

According to an example embodiment, as described with reference to FIG. 5, the processor 120 of the electronic device 101 may confirm whether a command is processible by the electronic device 101 prior to transmitting the command to the intelligent server 200. When determining that the command is not processible by the electronic device 101, the processor 120 may further transmit context information to the intelligent server 200.

For example, in the examples described with reference to FIG. 7, although the first context information that the displayed image is the first image 717 has been transmitted to the intelligent server 200, additional context information may be further transmitted. The processor 120 of the electronic device 101 may determine whether a voice command of “Delete this photo” is processible by the electronic device 101 (e.g., in its current state), and when determining that the voice command is not processible by the electronic device 101, and the displayed image is changed to the second image 727, information indicating a present display of the second image 727 may also be transmitted to the intelligent server 200. According to an example embodiment, the processor 520 of the intelligent server 200 may generate a processing result set including multiple results, such as deleting the first image 717 and deleting the second image 727. As described above, the processor 120 of the electronic device 101 may receive the processing result set, collect second context information in response to the receiving of the processing result set, and based on the second context information and the processing result set, generate and output a target processing result.

Examples may not be limited to the foregoing examples described with reference to FIGS. 6A through 7, and other examples may be made. For example, when the user utters a voice command stating, “Search for nearby restaurants,” a location of the electronic device 101 when receiving the voice command may be different than a location of the electronic device 101 when receiving a processing result from the intelligent server 200.

According to an example embodiment, state information on the electronic device 101, collected in response to the receiving of the voice command stating, “Search for nearby restaurants,” may include first location information. The first location information and the voice command stating, “Search for nearby restaurants” may be then transmitted to the intelligent server 200. The processor 520 of the intelligent server 200 may generate a processing result set including a first set of search results listing one or more nearby restaurants based on the first location information, and a second set of search result listing one or more nearby restaurants based on information on a second location that is located within a certain threshold distance of the first location.

According to an example embodiment, in response to receiving the processing result set, the processor 120 of the electronic device 101 may redetect a location of the electronic device 101, as second context information. When the second context information indicates that the second location is disposed within a certain perimeter of the first location, the processor 120 may generate as a target processing result, from the processing result set, a search result of nearby restaurants, based on the second location information, and output the target processing result.

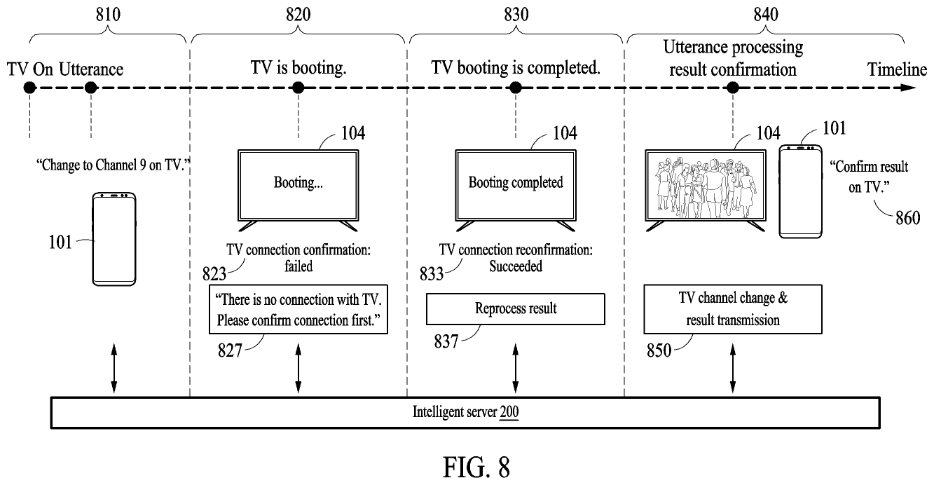

FIG. 8 is a diagram illustrating an operation when an intelligent server communicates with multiple electronic devices, according to various example embodiments.

Referring to FIG. 8, the intelligent server 200 may be the same as that described with reference to FIGS. 2 and 5 and may communicate with various electronic devices (e.g., the electronic devices 101 and 104). According to an example embodiment, the intelligent server 200 may process a voice command of a user by performing communication with a smartphone 101 and a TV 104. According to an example embodiment, the smartphone 101 may be the same as that described with reference to FIGS. 1 and 5, and the TV 104 may be the same as the electronic device 104 described with reference to FIG. 1.

According to an example embodiment, the user may utter a voice command stating, “Change to Channel 9 on the TV” via the smartphone 101. In response, the intelligent server 200 may execute a sequence of operations, including operation 810 of receiving the voice command, operation 820 of primarily confirming a connection with the TV 104, operation 830 of secondarily confirming the connection with the TV 104, and operation 840 of transmitting a processing result.

In operation 810, the processor 120 of the smartphone 101 may receive the voice command of the user stating “Change to Channel 9 on the TV,” and transmit the voice command to the intelligent server 200.

In operation 820, the processor 520 of the intelligent server 200 may confirm 823 the communicative connection with the TV 104. In the present example, the TV 104 is still booting up, and as such, the voice command may thus not be processible, may generate a processing result 827 stating, “There is no connection with the TV. Please confirm the connection first”.

In operation 830, before transmitting the processing result 827 to the smartphone 101 indicating that the voice command is not processible, the processor 520 may reconfirm in operation 833 the connection with the TV 104. According to an example embodiment, after reconfirming the connection, and after the booting of the TV 104 is complete, and the intelligent server 200 is successfully connected to the TV 104, the processor 520 in operation 837 may reprocess the results and generate, for example, a resulting output prompt 860 including “Confirm the result on the TV.”

In operation 840, the processor 520 of the intelligent server 200 may execute a change of channel to channel 9 on the TV 104, and transmit a processing result 850 to the smartphone 101. According to an example embodiment, the processing result may be output on the smartphone 101. For example, based on state information later confirmed, the output prompt 860 stating, “Confirm the result on the TV” may be output on the smartphone 101.

According to another example embodiment, as described with reference to FIGS. 6A through 7, from the intelligent server 200 to the smartphone 101, a processing result set including one or more processing results may be transmitted, and based on information collected in response to the receiving of the processing result set, a processing result may be output on the smartphone 101. For example, the processing result set may include a processing result of “There is no connection with the TV. Please confirm the connection first,” based on previously confirmed state information, and a processing result of “Confirm the result on the TV,” based on state information later confirmed. The processor 120 of the smartphone 101 may confirm a connection between the TV 104 and the intelligent server 200, and based on that, generate and output a target processing result.

<Operating Method of Electronic Device>

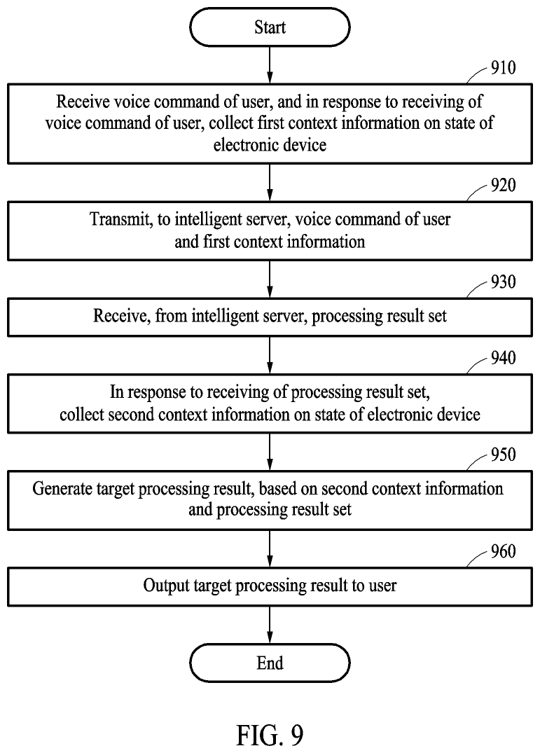

FIG. 9 is a flowchart illustrating an operation of an electronic device, according to various example embodiments.

Operations 910 through 960 may be performed by the processor 120 of the electronic device 101 described above with reference to FIG. 5. Therefore, the description provided with reference to FIGS. 1 through 8 will not be repeated for the sake of brevity.

According to an example embodiment, in operation 910, the processor 120 may receive a voice command of a user, and in response to receiving of the voice command, the processor 120 may detect a state of the electronic device 101 as first context information. According to various example embodiments, context information indicating a state of the electronic device 101 may include at least one of information on whether the electronic device 101 is locked, information on a current location of the electronic device 101, information on a ringtone set value, information on an operating application, information on a folding state, and information on whether location information is used. However, the context information may not be limited to the foregoing examples, and other pieces of information on a state of the electronic device 101 may be collected.

In operation 920, the processor 120 may transmit the voice command of the user and the first context information to an intelligent server 200. The intelligent server 200 may be the same as that described with reference to FIGS. 2 and 5, and may include a natural language platform 220 and a capsule DB 230.

In operation 930, the processor 120 may receive a processing result set from the intelligent server 200. As described above with reference to FIGS. 5 through 8, the processing result set may include a processing result that is generated based on the first context information. According to an example embodiment, the processor 520 of the intelligent server 200, using the natural language platform 220 and the capsule DB 230, may analyze the voice command of the user, and generate a processing result set, based on an inferred intent of the user, and the context information.

In operation 940, the processor 120, in response to the receiving of the processing result set from the intelligent server 200, may redetect the state of the electronic device 101 as second context information. According to an example embodiment, the second context information may be different from the first context information.

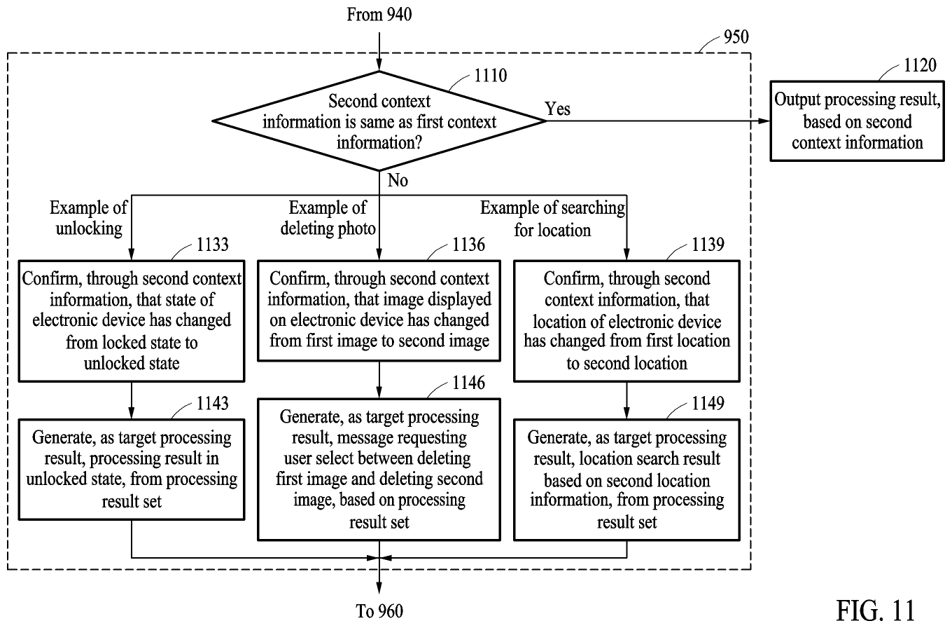

In operation 950, the processor 120 may generate a target processing result, based on the second context information (e.g., rather than the first context information, because the state of the device has changed) and the processing result set received from the intelligent server 200. As described above with reference to FIGS. 6A through 8, there may be various examples of the generating of the target processing result, as described with reference to FIG. 11.

In operation 960, the processor 120 may output a target processing result. The target processing result may be displayed in a text form or be output in a speech form.

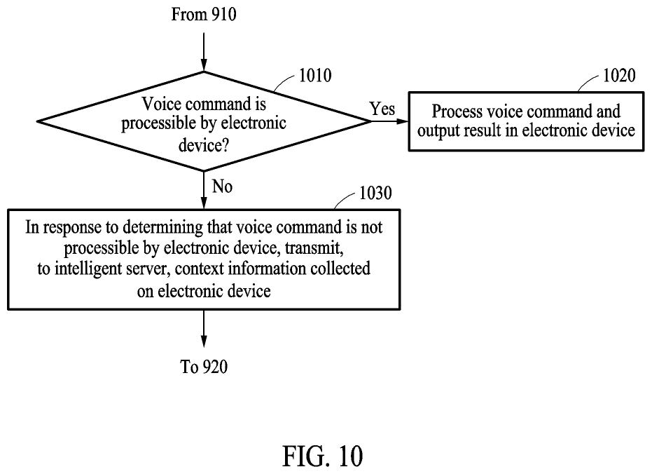

FIG. 10 is a flowchart illustrating an operation of an electronic device, based on whether a voice command is processible by the electronic device, according to various example embodiments.

Operations 1010 through 1030 may be performed by the processor 120 of the electronic device 101 described above with reference to FIG. 5. Therefore, the description provided with reference to FIGS. 1 through 9 will not be repeated for the sake of brevity.

Operations 1010 through 1030 may, in some embodiments, be performed between operations 910 and 920 of FIG. 9. According to an example embodiment, the processor 120, in operation 910, after collecting the first context information in response to the receiving of the voice command of the user, may determine, in operation 1010, whether the voice command of the user is processible by the electronic device 101. For example, as described above with reference to FIG. 5, on-device AI for processing the voice command (without a need to communicate with an external intelligent server 200) may be included in in the electronic device 101. For example, the on-device AI may have a same or similar configuration to the natural language platform 220 and the capsule DB 230 of the intelligent server 200.

According to an example embodiment, when the voice command of the user is determined to be processible by the electronic device 101 by the on-device AI, then in operation 1020, the processor 120 may process the voice command without communicating with the intelligent server 200, and output a result.

According to an example embodiment, when determining that the voice command is determined to be not processible by the electronic device 101, then in operation 1030, the processor 120 may redetect a state of the electronic device 101 as newly collected context information, and transmit the newly collected context information to the intelligent server 200.

As described above with reference to FIGS. 6A through 7, the processor 120 may receive an improved processing result set from the intelligent server 200 by further transmitting, to the intelligent server 200, the first context information collected in response to the receiving of the voice command of the user and context information on a state of the electronic device 101 when the processor 120 determines that the voice command is not processible by the electronic device 101.

FIG. 11 is a flowchart illustrating an operation of generating a target processing result, based on second context information and a processing result set, according to various example embodiments.

Operations 1110 through 1149 may be performed by the processor 120 of the electronic device 101 described above with reference to FIG. 5. Therefore, the description provided with reference to FIGS. 1 through 10 will not be repeated for the sake of brevity.

Operations 1110 through 1149 may correspond to an operation (e.g., operation 950 of FIG. 9) of generating the target processing result, based on the second context information and the processing result set described with reference to FIG. 9.

In operation 1110, the processor 120 may compare the second context information with first context information. When the first context information is the same as the second context information, the processor 120, in operation 1120, may output a processing result based on the second context information.

Operations 1133 and 1143 may correspond to the unlocking operations performed by the processor 120, described with reference to FIG. 6B. A voice command of a user may be a command that may need the electronic device 101 to be unlocked, and in operation 1133, the processor 120 may confirm, through the second context information, a state of the electronic device 101 has changed from a locked state to an unlocked state. In operation 1143, the processor 120 may generate, as a target processing result, from the processing result set, a processing result when the electronic device 101 is unlocked.

Operations 1136 and 1146 may correspond to the operations of the processor 120 deleting a photo, described with reference to FIG. 7. The voice command of the user may be a command to delete a photo, and in operation 1136, the processor 120 may confirm, through the second context information, an image displayed by the electronic device has changed from a first image to a second image. In operation 1146, the processor 120, based on the processing result set, may generate, as a target processing result, a message requesting the user select between deleting the first image and deleting the second image, for example, as on the screen 730 of FIG. 7.

Operations 1139 and 1149 may correspond to the location searching operations performed by the processor 120, described above with reference to FIG. 7. The voice command of the user may be a command to search for a nearby location, and in operation 1139, the processor 120 may confirm, through the second context information, a location of the electronic device 101 has changed from a first location to a second location. In operation 1149, the processor 120, may generate, as a target processing result, from the processing result set, a location search result, based on second location information.

The processor 120 may generate the target processing result each in operations 1143, 1146, and 1149 and output the target processing result in operation 960.

<Operating Method of Intelligent Server>

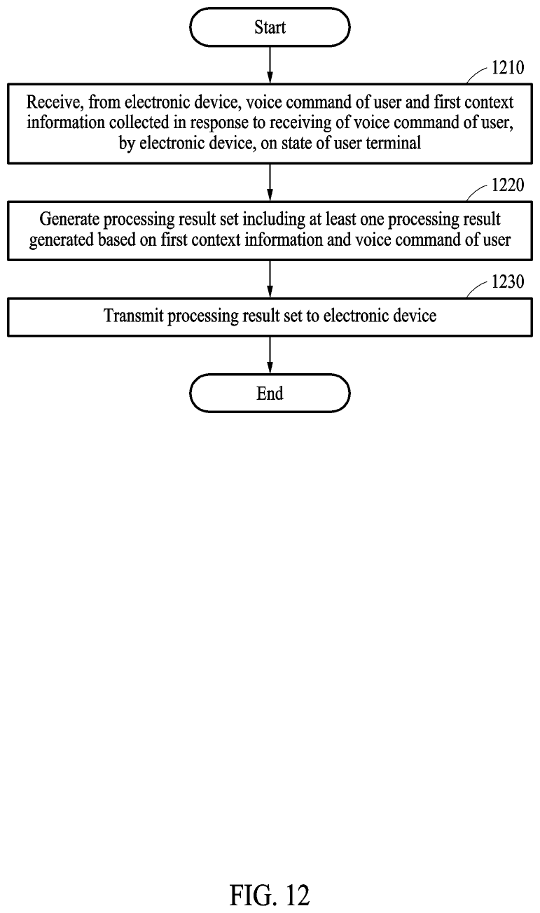

FIG. 12 is a flowchart illustrating an operation of an intelligent server, according to various example embodiments.

Operations 1210 through 1230 may be performed by the processor 520 of the intelligent server 200 described above with reference to FIG. 5. Therefore, the description provided with reference to FIGS. 1 through 11 will not be repeated for the sake of brevity.

In operation 1210, the processor 520 of the intelligent server 200, from the electronic device 101, may receive a voice command of a user and first context information. The first context information may have been collected by the electronic device 101, in response to the receiving of the voice command of the user in the electronic device 101.

In operation 1220, the processor 520 of the intelligent server 200 may generate a processing result set, including at least one processing result, based on the first context information and the voice command. As described above with reference to FIGS. 6A through 8, the processor 520 may determine (e.g., infer) the intent of the user through the natural language platform 220 and the capsule DB 230 and accordingly, may generate the processing result set.

The processor 520 of the intelligent server 200 may transmit the processing result set to the electronic device 101 in operation 1230. As described with reference to FIG. 9, the processor 120 of the electronic device 101, in response to the receiving of the processing result set, may collect second context information (e.g., operation 940 of FIG. 9), and based on the second context information and the processing result set, may generate a target processing result (e.g., operation 950 of FIG. 9), and output the generated target processing result to the user (e.g., operation 960 of FIG. 9).

According to an example embodiment, the electronic device 101 may include an audio module 170 for receiving a voice command of a user, a communication module 190 for communicating with the intelligent server 200 for processing the voice command of the user, a memory 130 for storing computer-executable instructions, and a processor 120 for executing the instructions by accessing the memory 130. The instructions may be configured to collect first context information on a state of the electronic device 101, in response to the receiving of the voice command of the user; transmit the first context information and the voice command of the user to the intelligent server 200; receive, from the intelligent server 200, a processing result set including a processing result generated based on the first context information and the voice command of the user; collect second context information on a state of the electronic device 101 in response to the receiving of the processing result set; generate a target processing result, based on the second context information and the processing result set; and output the target processing result.

According to an example embodiment, the instructions, when the voice command of the user is a command that may need the electronic device 101 to be unlocked, and when the first context information includes that the electronic device 101 is in a locked state, may be configured to receive, from the intelligent server 200, a processing result set including a first processing result in a locked state and a second processing result in an unlocked state; collect second context information on a state of the electronic device 101, in response to the receiving of the processing result set; when the second context information includes information that the electronic device is in an unlocked state, generate, from the processing result set, the second processing result, as a target processing result; and output the target processing result.

According to an example embodiment, the instructions, when the voice command of the user is a command to delete an image, and when the first context information includes a location where a first image is stored, may be configured to receive, from the intelligent server 200, a processing result set including a first processing result of deleting the first image and a second processing result of deleting a second image; collect second context information on a displayed image on the electronic device 101, in response to the receiving of the processing result set; when the displayed image is the second image, generate a target processing result based on the processing result set; and output the target processing result.

According to an example embodiment, the instructions may be configured to generate a message requesting the user select between deleting the first image and deleting the second image.

According to an example embodiment, the instructions, when the voice command of the user is a command to search for a location near the electronic device 101, and when the first context information includes first location information on the electronic device 101, may be configured to receive, from the intelligent server 200, a processing result set including a first processing result corresponding to the first location information and a second processing result corresponding to second location information, based on the first location information; collect second context information including location information of the electronic device 101, in response to the receiving of the processing result set; when the second context information includes the second location information, generate, as a target processing result, the second processing result; and output the target processing result.

According to an example embodiment, the instructions may be further configured to determine whether the voice command of the user is processible by the electronic device 101, and transmit, to the intelligent server 200, context information, collected in response to determination that the voice command of the user is not processible by the electronic device 101, on a state of the electronic device 101.

According to an example embodiment, context information on a state of the electronic device 101 may include at least one of information on whether the electronic device 101 is locked, information on a current location of the electronic device 101, information on a current ringtone set value, information on an operating application, information on a folding state, and information on whether location information is used.

According to an example embodiment, an operating method of an electronic device 101 includes receiving a voice command of a user; in response to the receiving of the voice command of the user, collecting first context information on a state of the electronic device 101; transmitting, to an intelligent server 200, the first context information and the voice command of the user; receiving, from the intelligent server, a processing result set including at least one processing result generated based on the first context information and the voice command of the user; in response to the receiving of the processing result set, collecting second context information on a state of the electronic device 101; generating a target processing result, based on the second context information and the processing result set; and outputting the target processing result.

According to an example embodiment, the operating method, when the voice command of the user is a command that may need the electronic device 101 to be unlocked, and when the first context information includes the electronic device 101 is in a locked state, may include receiving, from the intelligent server 200, a processing result set including a first processing result in a locked state and a second processing result in an unlocked state; collecting second context information on a state of the electronic device 101, in response to the receiving of the processing result set; when the second context information includes information that the electronic device is in an unlocked state, generating, as a target processing result, the second processing result from the processing result set; and outputting the target processing result.

According to an example embodiment, the operating method, when the voice command of the user is a command to delete an image, and when the first context information includes a location where a first image is stored, may include receiving, from the intelligent server 200, a processing result set including a first processing result of deleting the first image and a second processing result of deleting a second image; collecting second context information on a displayed image on the electronic device 101, in response to the receiving of the processing result set; when the displayed image is the second image, generating a target processing result based on the processing result set; and outputting the target processing result.

According to an example embodiment, when the displayed image is the second image, the generating of the target processing result based on the processing result set may include generating, as a target processing result, a message requesting the user select between deleting the first image and deleting the second image.

According to an example embodiment, the operating method, when the voice command of the user is a command to search for a location near the electronic device 101, and when the first context information includes first location information on the electronic device 101, may include receiving, from the intelligent server 200, a processing result set including a first processing result corresponding to the first location information and a second processing result corresponding to second location information, based on the first location information; collecting second context information including the location information on the electronic device 101, in response to the receiving of the processing result set; when the second context information includes the second location information, generating, as a target processing result, the second processing result; and outputting the target processing result.

According to an example embodiment, the operating method may further include determining whether the voice command of the user is processible by the electronic device 101; and transmitting to the intelligent server 200 context information, collected in response to determining that the voice command of the user is not processible by the electronic device 101, on a state of the electronic device 101.

According to an example embodiment, context information on a state of the electronic device 101 may include at least one of information on whether the electronic device 101 is locked, information on a current location of the electronic device 101, information on a current ringtone set value, information on an operating application, information on a folding state, and information on whether location information is used.

According to an example embodiment, an intelligent server 200 configured to process a voice command of a user may include a communication module 590 configured to receive, from the electronic device 101, the voice command of the user and first context information, collected in response to the receiving of the voice command of the user in the electronic device 101, on a state of an electronic device 101, and transmit, to the electronic device 101, a processing result set processing the voice command of the user; a memory 530 configured to store computer-executable instructions; and a processor 520 configured to execute the instructions by accessing the memory 530. The instructions may be configured to generate a processing result set including at least one processing result generated based on the first context information and the voice command of the user and transmit the generated processing result set to the electronic device 101.

According to an example embodiment, the instructions, when the voice command of the user may be a command that may need the electronic device 101 to be unlocked, and when the first context information includes information that the electronic device 101 is in a locked state, may be configured to generate a processing result set including a first processing result, when the electronic device 101 is in the locked state, and a second processing result, when the electronic device 101 is the unlocked state.

According to an example embodiment, the instructions, when the voice command of the user is a command to delete an image, and when the first context information includes a location where a first image is stored, may be configured to generate a processing result set including a first processing result of deleting the first image and a second processing result of deleting a second image, based on the location where the first image is stored.

According to an example embodiment, the instructions, when the voice command of the user is a command to search for a location near the electronic device 101, and when the first context information includes first location information on the electronic device 101, may be configured to generate a processing result set including a first processing result corresponding to the first location information and a second processing result corresponding to second location information, based on the first location information.

According to an example embodiment, context information on a state of the electronic device 101 may include at least one of information on whether the electronic device 101 is locked, information on a current location of the electronic device 101, information on a current ringtone set value, information on an operating application, information on a folding state, and information on whether location information is used.

The electronic device according to various example embodiments may be one of various types of electronic devices. The electronic device may include, for example, a portable communication device (e.g., a smartphone), a computer device, a portable multimedia device, a portable medical device, a camera, a wearable device, and a home appliance device. According to an example embodiment of the disclosure, the electronic device is not limited to those described above.

It should be understood that various example embodiments of the present disclosure and the terms used therein are not intended to limit the technological features set forth herein to particular embodiments and include various changes, equivalents, or any other variations for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “A, B, or C,” each of which may include any one of the items listed together in the corresponding one of the phrases, or all possible combinations thereof. Terms such as “first,” “second,” or “first” or “second” may simply be used to distinguish the component from other components in question, and may refer to components in other aspects (e.g., importance or order) is not limited. It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used in connection with various example embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example embodiment, the module may be implemented in a form of an application-specific integrated circuit (ASIC).

Various example embodiments as set forth herein may be implemented as software (e.g., the program 140) including one or more instructions that are stored in a storage medium (e.g., an internal memory 136 or an external memory 138) that is readable by a machine (e.g., the electronic device 101 of FIG. 1). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an example embodiment, a method according to various example embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various example embodiments, each component (e.g., a module or a program) of the above-described components may include a single entity or multiple entities, and some of the multiple entities may be separately disposed in different components. According to various example embodiments, one or more of the above-described components may be omitted, or one or more other components may be added. Alternatively or additionally, a plurality of components (e.g., modules or programs) may be integrated into a single component. In such a case, according to various example embodiments, the integrated component may still perform one or more functions of each of the plurality of components in the same or similar manner as they are performed by a corresponding one of the plurality of components before the integration. According to various example embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An operating method of an electronic device, the operating method comprising:
in response to receiving, via a microphone, a voice command of a user, detecting a state of the electronic device from as first context information;
transmitting, via a communication circuitry, and to an intelligent server, the first context information and the voice command of the user;
receiving, from the intelligent server, a processing result set including at least one processing result generated based on the first context information and the voice command of the user;
in response to the receiving of the processing result set, redetecting, via at least one processor, the state of the electronic device as second context information;
generating a target processing result, based on the second context information and the processing result set; and
outputting, via output circuitry, the target processing result.

2. The operating method of claim 1, wherein the voice command is executable in an unlocked state of the electronic device, and the electronic device is disposed in a locked state,
wherein the processing result set includes a first processing result corresponding to the locked state and a second processing result corresponding to the unlocked state, and
wherein when the second context information indicates the electronic device is in the unlocked state, the target processing result is generated from the second processing result.

3. The operating method of claim 1, wherein the voice command requests deletion of an image, and the first context information includes identification of a location where a first image is stored;
wherein the processing result set includes a first processing result indicating deletion of the first image, and a second processing result indicating deletion of a second image, based on the location where the first image is stored;
wherein the second context information indicates another image presently displayed on the electronic device; and
wherein when the displayed another image matches the second image, the target processing result is generated based on the processing result set.

4. The operating method of claim 3, wherein,
when the displayed another image matches the second image, generating the target processing result further includes generating a message prompting selection of either the first image or the second image for deletion.

5. The operating method of claim 1, wherein,
wherein the voice command of the user includes a request to search for a location near the electronic device, and the first context information includes a first location in which the electronic device is disposed,
wherein the processing result set includes a first processing result corresponding to the first location, and a second processing result corresponding to a second location,
wherein second context information is generated indicating a present location of the electronic device, in response to the receiving of the processing result set,
wherein when the present location matches the second location, the target processing result is generated using the second processing result.

6. The operating method of claim 1, further comprising:
determining whether the voice command is processible by the electronic device; and
in response to determining that the voice command of the user is not processible by the electronic device, detecting the state of the electronic device as third context information, and transmitting the third context information to the intelligent server.

7. The operating method of claim 1, wherein the context information further includes at least one of:
a locked or unlocked state of the electronic device, a current location of the electronic device, a current ringtone setting value of the electronic device, a current executing application of the electronic device, a folded or unfolded state of the electronic device, and a location access setting of the electronic device.

8. A non-transitory computer-readable storage medium storing instructions that, when executed by a processor, cause the processor to perform the operating method of claim 1.

9. An electronic device, comprising:
a microphone;
a communication module;
a memory configured to store computer-executable instructions; and
a processor operatively coupled to the microphone, the communication module and the memory,
wherein the instructions are executable by the processor to cause the electronic device to:
in response to receiving, via the microphone, a voice command of a user, detect a state of the electronic device from as first context information,
transmit, via the communication module, and to an intelligent server, the first context information and the voice command of the user,
receive, from the intelligent server, a processing result set including at least one processing result generated based on the first context information and the voice command of the user,
in response to the receiving of the processing result set, redetect, via at least one processor, the state of the electronic device as second context information,
generate a target processing result, based on the second context information and the processing result set, and
outputting the target processing result.

10. The electronic device of claim 9, wherein the instructions are further executable to:
wherein the voice command is executable in an unlocked state of the electronic device, and the electronic device is disposed in a locked state,
wherein the processing result set includes a first processing result corresponding to the locked state and a second processing result corresponding to the unlocked state, and
wherein when the second context information indicates the electronic device is in the unlocked state, the target processing result is generated from the second processing result.

11. The electronic device of claim 9, wherein the instructions are further executable to:
wherein the voice command requests deletion of an image, and the first context information includes identification of a location where a first image is stored;
wherein the processing result set includes a first processing result indicating deletion of the first image, and a second processing result indicating deletion of a second image, based on the location where the first image is stored;
wherein the second context information indicates another image presently displayed on the electronic device; and
wherein when the displayed another image matches the second image, the target processing result is generated based on the processing result set.

12. The electronic device of claim 11, wherein when the displayed another image matches the second image, generating the target processing result further includes generating a message prompting selection of either the first image or the second image for deletion.

13. The electronic device of claim 9, wherein the voice command of the user includes a request to search for a location near the electronic device, and the first context information includes a first location in which the electronic device is disposed,
wherein the processing result set includes a first processing result corresponding to the first location, and a second processing result corresponding to a second location,
wherein second context information is generated indicating a present location of the electronic device, in response to the receiving of the processing result set,
wherein when the present location matches the second location, the target processing result is generated using the second processing result.

14. The electronic device of claim 9, wherein the instructions are further executable to:
determine whether the voice command is processible by the electronic device; and
in response to determining that the voice command of the user is not processible by the electronic device, detect the state of the electronic device as third context information, and transmitting the third context information to the intelligent server.

15. The electronic device of claim 9, wherein the context information further includes:
a locked or unlocked state of the electronic device, a current location of the electronic device, a current ringtone setting value of the electronic device, a current operating application of the electronic device, a folded or unfolded state of the electronic device, and a location access setting of the electronic device.

16. An intelligent server for processing voice commands, the intelligent server comprising:
a communication module
a memory configured storing computer-executable instructions; and
a processor operably coupled to the memory and the communication module,
wherein the instructions are executable by the processor to cause the intelligent server to:
receive, via the communication module, from an external electronic device, a voice command of a user, and first context information indicating a state of the external electronic device,
process the received voice command and the first context information to generate a processing result set, and transmit the processing result set to the external electronic device via the communication module.

17. The intelligent server of claim 16, wherein the voice command is executable in an unlocked state of the electronic device, and the electronic device is disposed in a locked state,
wherein the processing result set includes a first processing result corresponding to the locked state and a second processing result corresponding to the unlocked state.

18. The intelligent server of claim 16, wherein the voice command requests deletion of an image, and the first context information includes identification of a location where a first image is stored, and
wherein the processing result set includes a first processing result indicating deletion of the first image, and a second processing result indicating deletion of a second image, based on the location where the first image is stored.

19. The intelligent server of claim 16, wherein the voice command of the user includes a request to search for a location near the electronic device, and the first context information includes a first location in which the electronic device is disposed, and
wherein the processing result set includes a first processing result corresponding to the first location, and a second processing result corresponding to a second location.

20. The intelligent server of claim 16, wherein the context information further includes at least one of: a locked or unlocked state of the electronic device, a current location of the electronic device, a current ringtone setting value of the electronic device, a current operating application of the electronic device, a folded or unfolded state of the electronic device, and a location access setting of the electronic device.
